(19) United States
(12) Patent Application Publication
(10) Pub. No.: US 2003/0009923 A1
(43) Pub. Date: Jan. 16, 2003

(54) Neon sign device having plain shape and method for manufacturing the same

(76) Inventor: Hong-Ju Ha, Youngin-Si (KR)

Correspondence Address: Fleshener & Kim, P O Box 221200, Chantilly, VA, 20153-1200, US

(21) Appl. No.: 10/203,180

(22) PCT Filed: Feb. 8, 2001
(86) PCT No.: PCT/KR01/00181

(30) Foreign Application Priority Data
Feb. 8, 2000 (KR) 2000/5751

(51) Int. Cl. G09F 13/26; H01J 9/00

(52) U.S. Cl. 40/545; 445/24

(57) ABSTRACT

The present invention relates to a neon sign device having a plain shape. The neon sign device having the plain shape according to the present invention comprises an upper glass sheet having electric discharge electrodes installed on its bottom surface; and a lower glass sheet attached closely to the bottom surface of the upper glass sheet and having an electric discharge space where an advertisement pattern to be represented is formed into a cavity. The neon sign device is generally made by bonding the upper and lower glass sheets after forming the electric discharge electrodes and the cavity in the upper and lower glass sheets, respectively. A fluorescent layer is also formed inside the cavity, and inert electric discharge gas is filled inside the cavity. For example, the cavity is formed by engraving it on a portion of a top surface of the lower glass sheet.

### TECHNICAL FIELD

The present invention relates to a neon sign device and a method for manufacturing the same, and more specifically, to a neon sign device that can have a thinner board shape and be constructed to display more elaborate patterns.

### BACKGROUND ART

In general, a neon sign is a light emitting device for displaying letters or pictures (hereinafter, term “advertisement pattern” is used to include all of the designs such as letters or logos for an advertisement) for the purpose of advertising. In a conventional neon sign, a shape of an advertisement pattern deforming a glass tube into a predetermined shape and injecting discharge gas such as neon into the glass tube.

That is, the advertisement pattern, such as letters or marks to be advertised, is formed by using glass tubes and such glass tubes are supported by a fundamental frame. As a result, the problem that the structure for the advertisement becomes generally voluminous is posed.

In addition to the voluminous problem, such conventional neon sign also has a problem that it can be easily broken by external force due to the structural fragility of the glass tubes. Moreover, because high voltage more than 1 kV is used as a main power supply, there is always a possibility of electric shock.

Additionally, in order to deform a glass tube having a given diameter, a portion of the glass tube is heated to obtain a partially melted state thereof, and then the glass tube is bent into a predetermined advertisement pattern. Therefore, the advertisement patterns, which can be provided by the conventional neon sign, are inevitably limited due to the diameter of the glass tube. Namely, as a matter of course, since the glass tube having the given diameter is used, it is impossible to make a letter or shape having a diameter smaller than that of the glass tube. It is also beyond doubt that the size of the letter or shape represented by the bent glass tube is necessarily limited.

U.S. Pat. No. 4,703,574 discloses a neon sign that solves the problems of a conventional neon sign using glass tubes as mentioned above. Although the '574 patent provides a luminous sign board having a planar board shape, it has a defect that its structure is somewhat complex.

That is, in order to provide the luminous sign board, the '574 patent employs three sheets of plate materials, a front transparent legend plate, a center feedthrough plate and a back crossover cavity plate. Such three plates are mutually combined to selectively form a cavity representing a letter or shape to be expressed. The luminous sign board is finally provided by discharging electricity inside the cavity.

However, the technology disclosed in the '574 patent also poses problems in that it has a complex structure, and in that because the neon sign uses a background light source of indirect illumination, the fluorescent color of neon is deteriorated.

### DETAILED DESCRIPTION OF THE INVENTION

present invention is conceived to solve the problems as mentioned above. A primary object of the present invention is to provide a neon sign device having a thinner and simple structure, and a method for manufacturing the same.

Another object of the present invention is to provide a neon sign device that can be embodied more compactly and at the same time, represent finer letters or marks, and a method for manufacturing the same.

A further object of the present invention is to provide a neon sign device that can solve the problems of structural fragility against the external force and risk of electric shock, and a method for manufacturing the same.

In order to achieve the above-mentioned objects of the present invention, there is provided a neon sign device having a plain shape, comprising an upper glass sheet having electric discharge electrodes installed on its bottom surface, and a lower glass sheet attached to the bottom surface of the upper glass sheet and having an electric discharge space where an advertisement pattern to be represented is formed into a cavity.

By forming the cavity of the electric discharge space between two glass sheets and installing the electric discharge electrodes so that electricity can be discharged inside the cavity, the plain neon sign device of which advertisement pattern can be illuminated efficiently can be provided.

In addition, a fluorescent layer is formed on an inner surface of the cavity, and inert electric discharge gas is filled inside the cavity

The cavity can be formed, for example, by etching, that is, by engraving it on a portion of a top surface of the lower glass sheet.

Furthermore, each of the electric discharge electrodes may comprise a transparent electrode and a bus electrode that applies an electric current to the transparent electrode.

The method for manufacturing a neon sign device having a plain shape according to the present invention is characterized in that it comprises the steps of forming electric discharge electrodes on an upper glass sheet; forming, on a lower glass sheet, a cavity serving as an electric discharge space and corresponding to an advertisement pattern; and closely attaching the upper and lower glass sheets.

According to an embodiment related to the electric discharge electrode forming step, the step comprises the steps of patterning transparent electrodes with ITO, and printing bus electrodes electrically connected to the transparent electrodes, respectively.

The method for manufacturing the neon sign device having the plain shape further comprises a step of printing and baking dielectric material on the top surfaces of the electric discharge electrodes, and also further comprises a step of coating and baking fluorescent material on an inner surface of the cavity of the lower glass sheet.

According to one embodiment, the step of closely attaching the upper and lower glass sheets can be carried out by printing and temporarily baking glass paste on one side of the upper or lower glass sheet and baking the upper and lower glass sheets in their combined state.

Furthermore, the method for manufacturing the neon sign device having the plain shape further comprises the steps of exhausting air in the cavity and injecting electric discharge gas thereinto after closely attaching the upper and lower glass sheets, and filling getter material into the cavity before or after injecting the electric discharge gas thereinto.

The method for manufacturing the neon sign device having the plain shape further comprises a step of removing foreign substances included inside the electric discharge space formed by the cavity. The step of removing foreign substances can be carried out by raising the temperature upto activation temperature of the getter material after injecting the getter material into the cavity.

The method for manufacturing the neon sign device having the plain shape further comprises a step of vacuum evaporating magnesium oxide on the upper glass sheet with the electric discharge electrodes formed.

### BRIEF DESCRIPTION OF DRAWINGS

FIG. 1a is a perspective view of an upper glass sheet according to the present invention.

FIG. 1b is a side view of the upper glass sheet according to the present invention.

FIG. 2a is a perspective view of a lower glass sheet according to the present invention.

FIG. 2b is a side view of the lower glass sheet according to the present invention.

FIG. 3 is a perspective view of a neon sign device having a plain shape according to the present invention.

FIG. 4 is a diagram showing the manufacturing process of the neon sign device having the plain shape according to the present invention.

### DETAILED DESCRIPTION FOR PREFERRED EMBODIMENT

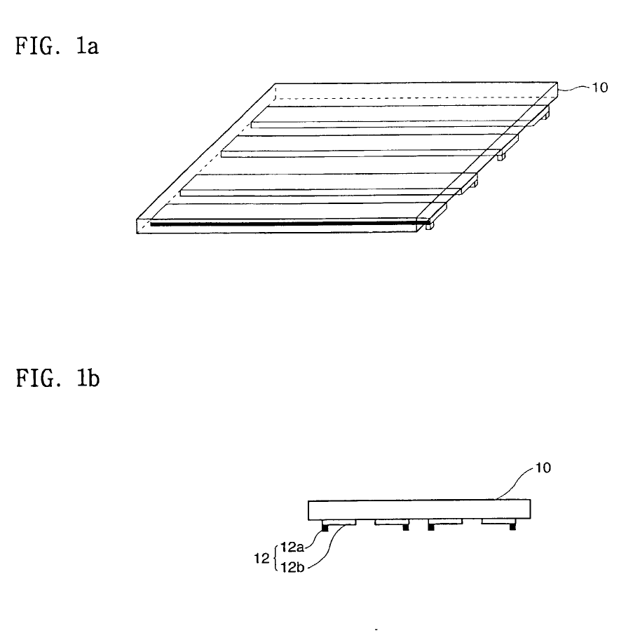

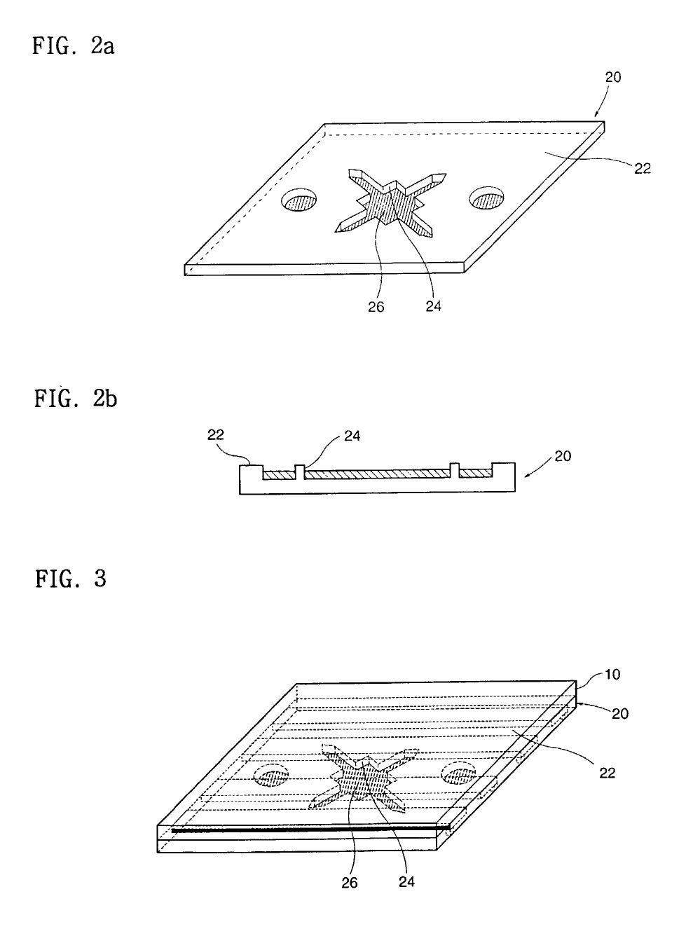

Hereinafter, an embodiment of the present invention will be explained in detail with reference to the accompanying drawings. First of all, the structure of a neon sign device having a plain shape according to the present invention will be explained with reference to FIGS. 1 and 2.

FIG. 1 shows an upper glass sheet 10 for constituting the neon sign device having the plain shape according to the present invention, and FIG. 2 shows a lower glass sheet 20. Such upper glass sheet 10 and lower glass sheet 20 are mutually attached to provide the neon sign device having the plain shape according to the present invention as shown in FIG. 3.

First, as shown in FIGS. 1a and 1b, the upper glass sheet 10 of the present invention is made of transparent glass material, and electric discharge electrodes 12 are attached on its bottom surface. The electric discharge electrodes 12 are used to generate electric discharge between them when an electric current of given voltage is applied to the neon sign device of the present invention. In the shown embodiment, a plurality of the electric discharge electrodes 12 are installed, and such electric discharge electrodes can be electrically connected outside the upper glass sheet 10 and the lower glass sheet attached closely thereto. As will be described later, using a plurality of the electric discharge electrodes 12 exemplifies the constitution for sufficient generation of electric discharge in case that the area of the cavity for representing letters or figures is large.

Further, according to the present invention, each of the electric discharge electrodes 12 comprises a transparent electrode 12b and a high conductivity electrode 12a for allowing smooth electric current flow to the transparent electrode 12b. The transparent electrode 12b means an electrode that is made of an optically transparent conductor and is electrically conductive. Generally, ITO (Indium Tin Oxide) can be used for the transparent electrode. In consideration that such transparent electrode 12b generally has high resistance, the high conductivity electrode 12a is installed on the transparent electrode 12b . The high conductivity electrode 12a functions to distribute the electric discharge electricity uniformly to the transparent electrode. In view of the resistance of the transparent electrode 12b, it is understood that the high conductivity electrode serves as a bus electrode.

Furthermore, when an electric current of given voltage is applied by being connected to a power supply through any separate connector which is not shown, the electric discharge electrode 12 should be able to generate electric discharge. Such electrical connection can be made outside the upper glass sheet 10 and the lower glass sheet 20.

Next, the lower glass sheet 20 of the present invention shown in FIG. 2 will be explained. The lower glass sheet 20 constitutes a complete neon sign device when combined with the upper glass sheet 10. It is preferred that the lower glass sheet 20 be formed by the same transparent glass material as the upper glass sheet 10.

As shown in FIGS. 2a and 2b, the lower glass sheet 20 is formed with a cavity 24 for forming an electric discharge space on a top surface 22 of the lower glass sheet. The cavity 24 for electric discharge is a portion for forming the electric discharge space when the upper glass sheet 10 and the lower glass sheet 20 are substantially attached closely to each other. Therefore, the cavity 24 for electric discharge is constructed to form an advertisement pattern such as letters or designs to be advertised by the neon sign. For example, the cavity 24 can be formed in the shape of letters of a company name, or company logo to be advertised.

Moreover, in the shown embodiment, such cavity 24 for electric discharge can be formed by engraving it on a portion of the planar top surface 22 of the lower glass sheet 20.

For example, it is possible to form the cavity 24 by engraving it in a known etching method. In addition to the etching method, it is also possible to form the cavity 24 by means of sand blasting, grinding or engraving by a laser beam.

However, it is obvious that present invention cannot be limited to such engraving method in forming the cavity 24. That is, the cavity 24 can be arbitrarily constituted by any method as far as the upper glass sheet 10 and the lower glass sheet 20 can form a predetermined electric discharge space when they are attached to each other. In the engraving method, the cavity is formed by removing the portion corresponding to the cavity 24, but, for example, the cavity 24 can be also formed by an embossing method by which the level of the top surface 22 except for the cavity 24 is raised.

Namely, in the present invention, it is enough to form cavity 24 where the electric discharge occurs by the electric discharge electrodes 12, with the upper glass sheet 10 and the lower glass sheet 20 attached to each other.

On the inner surface of the cavity 24 completed by the aforementioned process, fluorescent material is coated and dried. Thus, a fluorescent layer 26 is formed on the inner surface of the cavity 24 Since light dispersion effect is added to the luminosity by forming such fluorescent layer 26, it is possible to represent a high definition and color contrasting advertisement pattern comprised of figures or letters. Furthermore, when the upper glass sheet 10 has been attached to the lower glass sheet 20, predetermined gas is injected into the space formed by the cavity 24. The injected gas is mixed gas of neon, zeon and helium gas. That is, the gas injected into the cavity 24 for electric discharge is generally inert electric discharge gas, which should not be limited thereto.

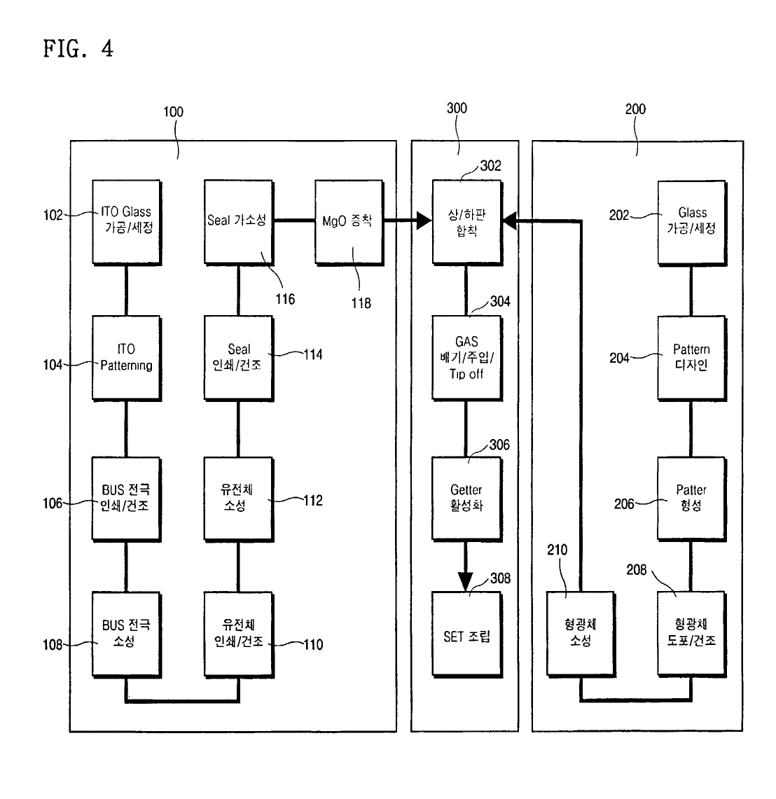

Next, the manufacturing method for a neon sign device of the present invention will be described with reference to FIG. 4 which shows a diagram of process of the method according to the present invention.

First, in FIG. 4, the block designated by the reference numeral 100 corresponds to the manufacturing process for the upper glass sheet 10, the block designated by the reference numeral 200 corresponds to the manufacturing process for the lower glass sheet 20, and the process designated by the reference numeral 300 shows the process for assembling the upper glass sheet 10 and the lower glass sheet 20 by closely attaching one to the other.

First of all, the process for manufacturing the upper glass sheet 10 will be explained. In step 102, the upper glass sheet to which a transparent electrode such as ITO should be attached is cut into a predetermined size and then cleaned. In step 104, the transparent electrodes 12b are patterned on the cleaned upper glass sheet 10. By means of patterning the transparent electrodes, the transparent electrodes 12b shown in FIG. 1 are mounted on the bottom surface of the upper glass sheet 10 in an appropriate array. Further, in step 106, the bus electrodes that function as the high conductivity electrodes 12a are printed along one side of the respective transparent electrodes 12b and then dried. In step 108, by means of baking the bus electrodes, the high conductivity electrodes are completely formed on the upper glass sheet 10. When the formation of the transparent electrodes 12b and the high conductivity electrodes 12a is completed through the above-mentioned procedure, the formation of the electric discharge electrodes can be considered as being finished.

In the next step 110, on the top surfaces of the electric discharge electrodes 12 that are formed on the bottom surface of upper glass sheet 10 by the above-mentioned procedure, a process for printing and drying dielectric material for the purpose of insulation between the electric discharge electrodes, and a process for baking such layer of dielectric material are carried out (step 112). Even though a coating of dielectric material forms the dielectric material layer, it is practically possible to generate electric discharge between the electric discharge electrodes by applying alternating voltage in the form of pulse or sine wave to the electric discharge electrodes.

Next, in step 114, sealing material such as glass paste having a low melting point is printed on the peripheral surface of the upper glass sheet 10 and then dried. In step 116, the sealing material is temporarily baked. The temporary baking of the sealing material such as glass paste after printing the sealing material is to bond the bonding surfaces of the upper and lower glass sheets sufficiently and thoroughly when the upper glass sheet is bonded to the lower glass sheet 20, as will be described later.

After finishing the temporary baking of the sealing material through step 116, a process for vacuum evaporating magnesium oxide (MgO) on the surface is carried out in step 118. By vacuum evaporating MgO that is electron emitting material, the electric discharge electrodes can be protected and the electric discharge can be also easily generated.

Through the above-mentioned procedure, the process for manufacturing the upper glass sheet 10 is completed. Next, the manufacturing process for the lower glass sheet 20 will be explained.

First, in step 202, the procedure for processing and cleaning the lower glass sheet is carried out. On the top surface of the lower glass sheet 20, the processes for designing and patterning an advertisement pattern in the form of desired words or logos are carried out (steps 204 and 206). The pattern means the cavity 24 for advertising a draft of an advertisement.

Then, the process of coating and drying the fluorescent material on the inner surface of the cavity 24 is carried out (step 208). In step 210, the fluorescent material is completely adhered to the lower glass sheet by baking the fluorescent material.

Through above-mentioned procedure, the process for manufacturing the lower glass sheet is completed. Next, the neon sign device having the plain shape according to the present invention is completed by attaching upper glass sheet 10 and lower glass sheet 20, which are completed through above-mentioned procedure, to each other.

That is, in step 302, the neon sign device shown in FIG. 3 is completed by baking the upper glass sheet 10 and the lower glass sheet 20 in their attached state. Inside the neon sign device fabricated as above, the electric discharge electrodes are incorporated therein, and the electric discharge space has been formed since the cavity 24 for representing a draft of a given advertisement has a space in the closely attached portion of the both the upper and lower glass sheets. Additionally, in step 302, a tip (not shown) made by a glass tube communicating with the cavity between the upper glass sheet 10 and the lower glass sheet 20 that are closely bonded together through the baking process in the attached state is installed on either side of both the upper and lower glass sheets. Substantially, such tip is made integrally when the upper glass sheet 10 and the lower glass sheet 20 are attached to each other.

In step 304, through the tip communicating with the cavity 24, the gas for electric discharge and getter which is high oxidative material, as will be described later, are injected.

For example, mixed gas of neon, zeon and helium can be injected to the cavity 24. Such mixed gas does not substantially give out any color upon electric discharge, and when only ultraviolet rays are emitted by electric discharge, such ultraviolet rays illuminate the fluorescent material coated and baked on the cavity.

However, in the present invention, the gas injected into the cavity 24 should not be limited to the above-mentioned mixed gas. For example, neon gas which emits light of a given wave length upon electric discharge may be injected thereinto. Even in the case where neon gas that emits light of a specific component is injected into the cavity 24, both of the light emitted by the neon gas and the light emitted by the luminescence of fluorescent material can be utilized as advertisement media because the light emitted by the fluorescent material coated on the inner surface of the cavity 24 can be also visually recognized

In step 304, after injecting a specific gas into the cavity 24, the tip for injecting gas is tipped off and the communication portion is hermetically sealed. In practice, such process can be carried out by melting and clogging the tip of the glass tube.

After the formation of a space for electric discharge of which interior is totally isolated by sealing the tip after the injection of a specific gas and getter into the cavity 24 is completed, activation of the getter is carried out in step 306. In fact, since residual gas, such as oxygen, nitrogen, etc., and moisture remain inside the space for electric discharge formed as the cavity, the process for completely absorbing such residual substances by activating the high oxidative getter including zirconium, vanadium, etc. is carried out in step 306. Through such process for activating the getter, for example, heating up to high atmosphere temperature of about 300° C., the above-mentioned getter is activated to absorb the residual substances such as residual gas and moisture.

When such getter activation process is completed, the manufacturing of the neon sign device having the plain shape has been completed. In step 308, the neon sign device having the plain shape is assembled with its peripheral components so that the finished neon sign device having the plain board shape can be practically mounted indoors or outdoors.

When the neon sign device of the present invention is completed through above-mentioned procedure, an electrical current is applied to the electric discharge electrodes 12 to generate electric discharge between the electric discharge electrodes that are exposed to each other.

By means of the ultraviolet rays emitted by such electric discharge, the fluorescent material coated on the bottom surface of the cavity illuminates the advertisement pattern such as letters or logos formed by the cavity, so that desired advertising effect is obtained.

According to the present invention as described above, it is understood that the basic spirit of the present invention is that the electric discharge space is formed between two glass sheets of the upper and lower glass sheets, and that the electric discharge occurs inside such electric discharge space by electric discharge electrodes as transparent electrodes. In addition, there is no doubt that various modifications can be made to the invention without departing from the spirit thereof by a person having ordinary skill in the art.

Industrial Applicability

It is understood that the present invention as such provides advantages as follows:

First, the neon sign device according to the present invention has the plain shape formed by two glass sheets. Thus, in comparison to a conventional neon sign device, it has a relatively thinner shape and a simple structure. Such advantages in appearance and structure mean that neon sign device of the present invention can be easily mounted in any spatial condition.

Second, according to the present invention, the electric discharge practically occurs in the space referred to as cavity. Thus, in comparison to the conventional neon sign device, an extremely small electric discharge space can be realized, and at the same time, finer letters or marks can be represented. Such advantages mean that it is possible for consumers to understand more fine advertisement patterns even in a smaller space.

Additionally, since the neon sign device of the present invention can be driven with low voltage due to the electric discharge voltage which generally ranges from 100V to 600V, it is possible to provide a safe electric discharging sign device in comparison to the neon sign device which is generally driven by the discharge voltage mainly ranging from 1 kV to 15 kV

1. A neon sign device having a plain shape, comprising:
an upper glass sheet having electric discharge electrodes installed on its bottom surface; and
a lower glass sheet attached closely to said bottom surface of said upper glass sheet and having an electric discharge space where an advertisement pattern to be represented is formed into a cavity.

2. The neon sign device as claimed in claim 1, wherein a fluorescent layer is formed on an inner surface of said cavity.

3. The neon sign device as claimed in claim 1, further comprising inert electric discharge gas that is injected into said cavity.

4. The neon sign device as claimed in claim 1, wherein said cavity is engraved on a portion of a top surface of said lower glass sheet.

5. The neon sign device as claimed in claim 1, wherein each of said electric discharge electrodes comprises a transparent electrode, and a bus electrode for applying an electric current to said transparent electrode.

6. A method for manufacturing a neon sign device having a plain shape, comprising the steps of:
forming electric discharge electrodes on an upper glass sheet;
forming, on a lower glass sheet, a cavity serving as an electric discharge space and corresponding to an advertisement pattern; and
attaching closely said upper and lower glass sheets.

7. The method as claimed in claim 6, wherein said step of forming said electric discharge electrodes comprises the steps of
patterning transparent electrodes with ITO, and
printing bus electrodes electrically connected to said transparent electrodes, respectively.

8. The method as claimed in claim 6, further comprising a step of printing and baking dielectric material on said top surfaces of said electric discharge electrodes.

9. The method as claimed in claim 6, further comprising a step of coating and baking fluorescent material on an inner surface of said cavity of said lower glass sheet.

10. The method as claimed in claim 6, wherein said step of attaching said upper and lower glass sheets is carried out by printing and temporarily baking glass paste on one side of said upper or lower glass sheet and by baking said upper and lower glass sheets in their combined state.

11. The method as claimed in claim 6, further comprising a step of exhausting air in said cavity and injecting electric discharge gas into said cavity after closely attaching said upper and lower glass sheets.

12. The method as claimed in claim 10, further comprising a step of filling getter material into said cavity before and after injecting said electric discharge gas thereinto.

13. The method as claimed in claim 6, further comprising a step of removing foreign substances included in said electric discharge space formed by said cavity after closely attaching said upper and lower glass sheets.

14. The method as claimed in claim 13, wherein said step of removing foreign substances is carried out by raising the temperature up to activation temperature of said getter material after injecting said getter material into said cavity

15. The method as claimed in claim 6, further comprising a step of vacuum evaporating magnesium oxide on said upper glass sheet with said electric discharge electrodes formed.
